(19) United States
(12) Patent Application Publication
(10) Pub. No.: US 2007/0070077 A1
(43) Pub. Date: Mar. 29, 2007

(54) Instruction removing mechanism and method using the same

(75) Inventor: R-ming Hsu, Jhudong Township (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Silicon Integrated Systems Corp.

(21) Appl. No.: 11/234,943

(22) Filed: Sep. 26, 2005

(51) Int. Cl. G09G 5/00

(52) U.S. Cl. 345/582

(57) ABSTRACT

The present provides an instruction removing mechanism and a method using the same. The instruction removing mechanism is capable of scanning a graphic program to determine whether there is any simple texture load instruction (texld instruction) in the program. The simple texld instructions will be transmitted directly to the texture unit and deleted from a texld instruction collector to prevent the pixel shader executing the simple texld instructions before the texture unit.

### FIELD OF THE INVENTION

The present invention generally relates to a mechanism and method thereof for graphic processes, and more particularly, to a simple instruction removing mechanism and method using the same for the graphic processes.

### BACKGROUND OF THE INVENTION

A pixel shader capable of handling the pixel programmable process is utilized in a 3-dimensional graphic processor unit (GPU) or a 3-dimensional graphic accelerator. Recently, some application program interfaces (API) have included the pixel shader inside, e.g. the Pixel Shader in DirectX version 8.0 and the Fragment Processor in OpenGL version 1.5, each interface has defined its own shader language which is similar to the assembled languages.

Please refer to FIG. 1. A conventional GPU pipeline comprises some primary steps for processing the pixels. First of all, a vertex processing procedure is utilized to perform a geometric transform and lighting process 902, and perform a process 904 of clipping the vertexes to a viewport. Further, a triangle setup process 906 is capable of combining each vertex set into a triangle and paving each triangle by 2-dimensional pixels. These 2-dimensional pixels are transmitted for performing a pixel processing procedure. In the pixel processing procedure, a texture unit 908 is capable of figuring out the texture coordinates of the 2-dimensional pixels according to the pixel positions and the texture coordinates of the triangle vertexes by executing an interpolated calculation. The texture coordinates of the 2-dimensional pixels are used to sample a texture map for acquiring the texture colors of the pixels. Meanwhile, a color interpolator 910 is capable of figuring out the vertex colors according to the pixel positions and the colors of corresponding triangle vertexes by executing an interpolated calculation. The texture colors and vertex colors are processed to obtain the final colors of the pixels by performing a blending procedure 912. Eventually, a depth processing procedure 914 is capable of drawing the final colors of the pixels to produce a complete frame by comparing which pixels are most approximate to the viewport.

The vertex processing procedure and pixel processing procedure are became programmable for complying with the demand of hardware accelerating calculation to handle more complex effects in recent API. As shown in FIG. 2, a vertex shader 916 in DirectX (similarly, a vertex processor in OpenGL) is used to replace the geometric transform and lighting process in the pixel processing procedure, and a pixel shader in DirectX (similarly, a fragment processor in OpenGL) is used to replace the blending procedure in the pixel processing procedure. The vertex shader 916 and pixel shader 926 are the general purpose processor with special instructions capable of executing the programs of shader language respectively. The vertex shader 916 is capable of executing a vertex shader program to process the effects in the vertex level, and pixel shader 926 is capable of executing a pixel shader program to process more sophisticated effects. Therefore, most effects can be done by cooperation of the vertex shader program and pixel shader program properly for improving the hardware performance.

A prior pixel shader shown in FIG. 3, is evolved from the programmable blending process of the texture colors and vertex colors in the pixel processing procedure. The texture colors obtained from the texture shade 932 and the vertex colors calculated from the color interpolator 934 are blended by executing the pixel shader program of the pixel shader 936 in order to acquire final color and depth of each pixel which will be proceeded to the depth processing procedure.

Please refer to FIG. 4. Nowadays, a latest pixel shader performs more sophisticated processes for realizing more complicated lighting effects and surface processing effects. The present pixel shader 946 is required to perform the algorithmic instructions for executing the interpolated calculation of the texture coordinates from the texture unit 942, then the processed coordinates are transmitted back to the texture unit 942 for sampling the texture colors through a texture map by a specific texture loading instruction (e.g. a texld instruction in DirectX) and pass to pixel shader 946 for blending processing.

FIG. 5 shows an example of the pixel shader program in DirectX. The DirectX pixel shader defines several sets of registers which include general registers rn, texture coordinate registers tn, texture number registers sn, vertex color registers vn and final color registers oCn. The texture coordinates are obtained by the interpolated calculation from the texture unit 950, and the texture numbers are utilized to designate the textures in the texture unit 950. The pixel shader program comprises four primary phases: (a) coordinate calculation; (b) texture processing; (c) blending processing; and (d) issue out.

(a) The tn values and rn values are processed by a general algorithmic calculation in coordinate calculation phase, and the results of the calculation will be stored in the general registers rn.

(b) In the texture processing phase, texture unit 950 sample the texture colors from a texture map which is designated by texture number register sn according to the coordinates stored in the texture coordinate registers tn and general registers rn by issuing a texture load instruction texld. The information of texture colors will be transmitted back to the general registers rn.

(c) The texture colors in register rn and vertex colors in registers vn are blended by the general algorithmic calculation in the blending processing phase, and the results of the calculation will be stored in the general registers rn.

(d) In the issue out phase, the final colors in registers rn will be transmitted forward to perform a depth processing procedure.

FIG. 6 shows a block diagram of a conventional pixel shader. First of all, the pixel shader program is inputted into an instruction queue 970. Each pixel of the tiles from the triangle setup procedure has to be processed once by every instruction in the instruction queue 970 and the processed results will be transmitted proceed to the depth processing procedure 972 by an issue out instruction. A program counter (PC) 965 fetches the instructions and transmits the instructions to a decoder 966 for decoding to perform algorithmic logic unit (ALU) 968 operations.

There are data dependencies and control dependencies between the instructions, but not between the pixels. The data dependency means that a latter instruction has to be waited until a former instruction completed if the latter instruction has to be executed according to the result of the former instruction. The control dependency means that the program executes the instructions according to its orders inherently, unless there is a complex determining mechanism of data dependency for out-of-order execution. Thus, a plurality of pixels can be processed synchronously in one execution cycle. Moreover, pixels of a plurality of execution cycles can be piled in the pixel shader and be processed in a same batch, cycle by cycle on the same instruction. By this way, after the last cycle pixels of the batch are issued, the first cycle pixels of the batch may had been completed and can be issued, thus can avoid or reduce the pipeline bubbles caused by data dependencies. However, assuming N pixels can allowed to be processed in the same batch, N sets of registers defined in instruction sets of pixel shader specification are needed to be stored in the pixel shader 960.

Assuming that the ALU 968 can execute W pixels simultaneously in each cycle, and the longest executing period of the usual instructions is l cycles, then the pixel shader 960 needs N registers 962 for storing N pixels executed in a same batch, wherein N is equal to or large than l×W. Otherwise, it will cause the pipeline throttling when the all pixels which can be executed in a same batch are executing, but the initially executed pixel is not completed yet. This will cause that the next instruction cannot be executed consecutively.

The texture load instruction texld has the ultra longest executing period in the usual instructions because of the sophisticated interpolated calculation. The texture load instruction texld is executed by the texture unit sample the texture color from the indicated texture map then pass back to the pixel shader 960. The sampling process is a very complex interpolated calculation and the texture map is stored in the memory, so that even speeding up by the cache memory, the texld instruction will take more than 30 cycles, and it will take hundreds of cycles by reading from the memory when the cache miss occurred. According to the increasing volume of the registers of the new generation pixel shader (increasing from about 300 bit/pixel to about 600 bit/pixel) and the increasing pixel number which can be executed simultaneously by ALU 968 in one cycle (recently, increasing from a pixel/cycle to 16 pixel/cycle), the pixel shader 960 is nearly impossible to store enough volume of registers 962. It will cause a serious pipeline throttling and the increasing process bandwidth will become useless. The miss rate of the cache memory becomes larger due to the larger and more sophisticated texture map. Thus, the long executing period of texld instruction brings a serious problem of pixel process performance.

Recent light and shadow effects will also bring a high cache miss rate, such as a normal map technology. The normal map technology is an advanced bump-mapping technology. The normal map technology is capable of increasing object details without more complex polygonal mode. The normal map is a special texture data which includes the detailed information of polygonal objects. However, the normal map technology requires a higher volume of data and will cause higher texture cache miss rate.

The serious pipeline throttling is due to the data dependency and control dependency between the texld instruction and other instructions. For example, a simple case shown in FIG. 7, the first instruction of the program is a texld instruction which the further else instructions follow. There is only one texld instruction in the program in this example. FIG. 7 shows the executing schedule of the pipeline and indicates run or idle statuses of the pixel shader and the texture unit. Assuming that the pixel shader in a same batch executes N pixels with an ALU bandwidth of l pixel/cycle. The texture unit samples the texture color and passes back to the pixel shader according to the texld instruction. The other instructions have to be waited until the texture unit has accomplished the texld instruction. The pixel shader has to be idled for l−N cycles before executing the other instructions since N is smaller than l. At the same time, the texture unit will not receive the texld instruction of next N pixels so that the texture unit has to be idled. In the meanwhile the texture unit becomes a performance bottleneck so the idle time of the texture unit causes the significant pipeline throttling. Furthermore, as the number i of other instructions increasing, the idle time of the texture unit will be multiplied to N×i.

A method is disclosed by U.S. Pat. No. 5,978,871 for layering cache and architectural specific functions within a cache controller to permit complex operations to be split into equivalent simple operations. Architectural variants of basic operations may thus be devolved into distinct cache and architectural operations and handled separately. The logic supporting the complex operations may thus be simplified and run faster. However, the method for layering cache and architectural specific functions is not suitable to the case that the instructions can not be split into equivalent simple instructions.

U.S. Pat. No. 6,609,190 discloses a processor, a data processing system and an associated method utilizing primary and secondary issue queues. The processor is suitable for dispatching an instruction to an issue unit. The issue unit is adapted to allocate dispatched instructions that are currently eligible for execution to a primary issue queue and to allocate dispatched instructions that are not currently eligible for execution to a secondary issue queue. However, the instruction dispatched to the secondary issue queues will still pending in the execution pipelines of the processor until it is determined that the instruction is eligible or rejected.

It is easy to be understood that even without the data dependency between the instructions, the serious pipeline throttling still occur because of the control dependency between the texld instruction and other instructions. The control dependency between the texld instruction and other instructions must be eliminated in order to improve the graphic process performance.

### SUMMARY OF THE INVENTION

The primary object of the present invention is to provide a mechanism and method thereof for removing a simple instruction in the graphic processes.

Another object of the present invention is to provide a mechanism and method thereof for reducing the idle time of a texture unit in a graphic processor.

According to the above objects, the present invention sets forth an instruction removing mechanism and a method using the same. The instruction removing mechanism is capable of scanning a graphic program to determine whether there is any simple texture load instruction (texld instruction) in the program. The simple texld instructions will be transmitted directly to the texture unit and deleted from a texld instruction collector to prevent the pixel shader executing the simple texld instructions before the texture unit.

A method of performing the detection and remove of the simple texld instructions comprises the steps of:
Step 1 Start;
Step 2 Loading a original pixel process program;
Step 3 Clearing the texture table;
Step 4 Scanning a instruction in the original program;
Step 5 Decoding the instruction;
Step 6 Determining whether the instruction is a simple texld instruction, if so, go to
step 7; else go to step 8;
Step 7 Checking if the texld table is full, if so, go to step 8; else go to step 9;
Step 8 Writing the instruction to a new program;
Step 9 Writing the simple texld instruction to the texld table;
Step 10 Determining whether there is another instruction, if so, go to step 4; else go to step 11;
Step 11 Ready to run a new program and transmitting the texture commends to the texture unit;
Step 12 End.

The advantages of the present invention include: (a) improving the performance of the graphic process, (b) reducing the idle time of the texture unit, (c) providing a simple texld instruction removing mechanism and method thereof to efficiently utilize the physical registers allocated to the graphic programs.

### BRIEF DESCRIPTION OF THE DRAWINGS

FIG. 1 shows a conventional a conventional GPU pipeline;

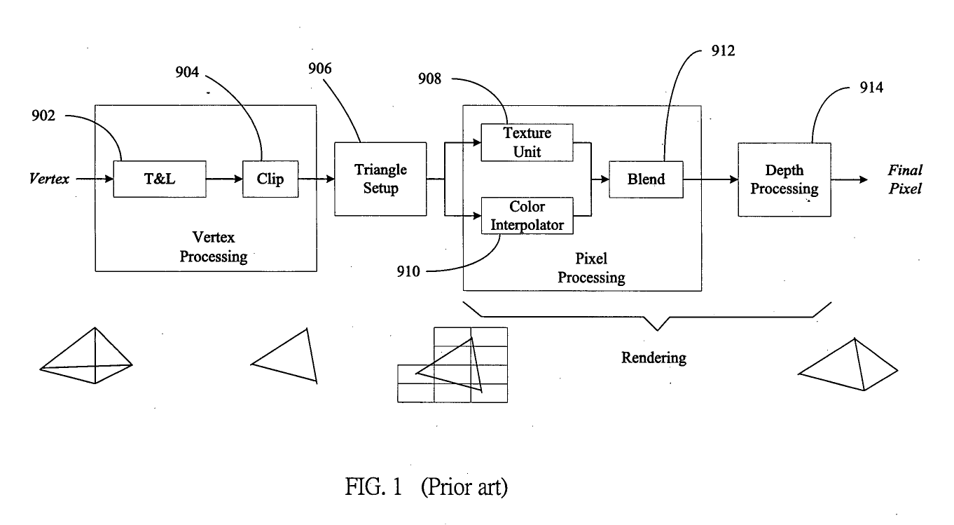

FIG. 2 shows another conventional GPU pipeline;

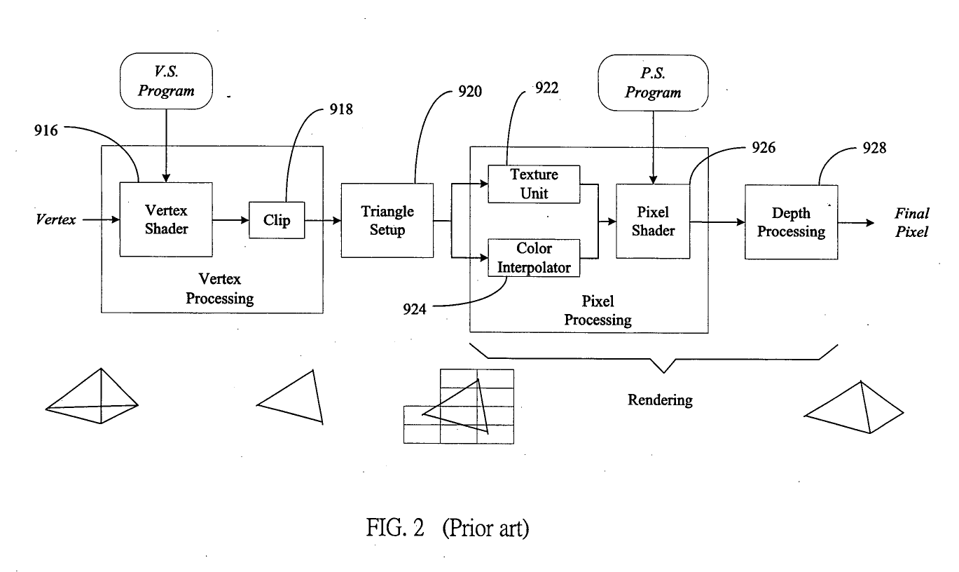

FIG. 3 illustrates a conventional pixel process;

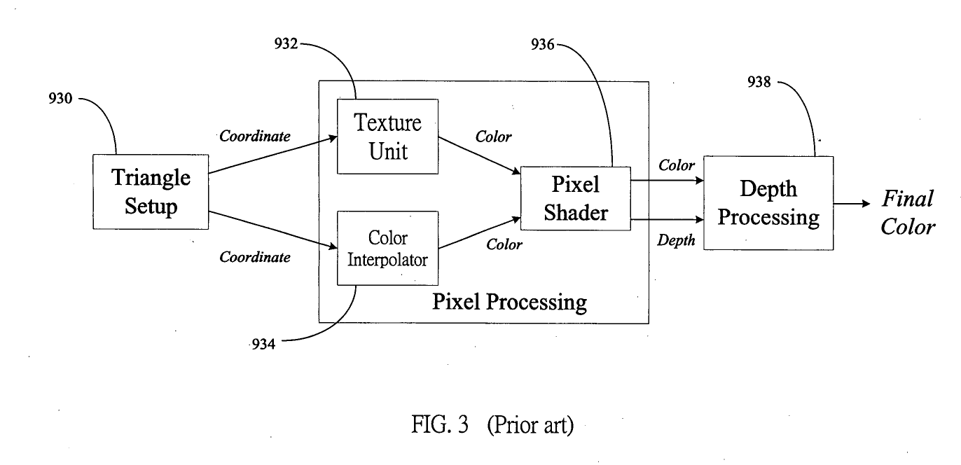

FIG. 4 illustrates another conventional pixel process;

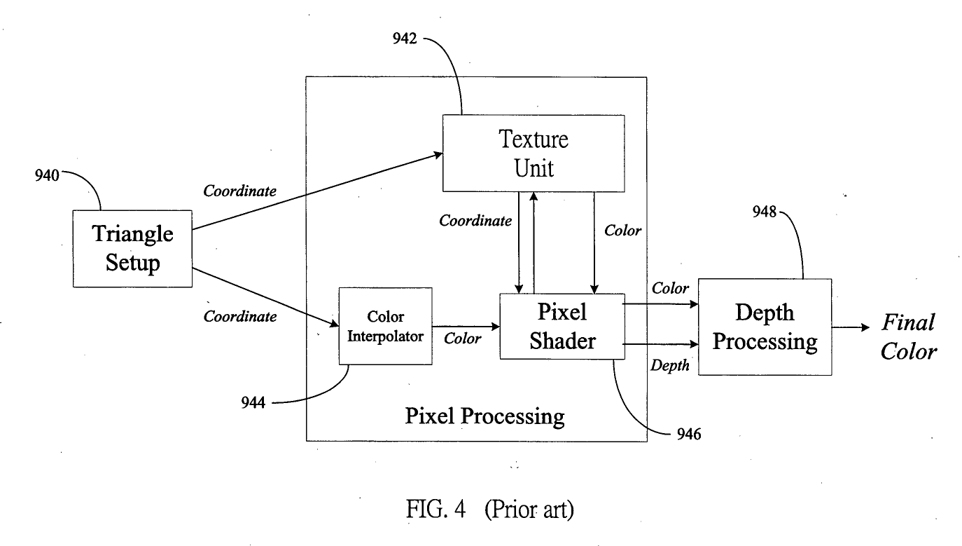

FIG. 5 illustrates an example of the pixel shader program in DirectX;

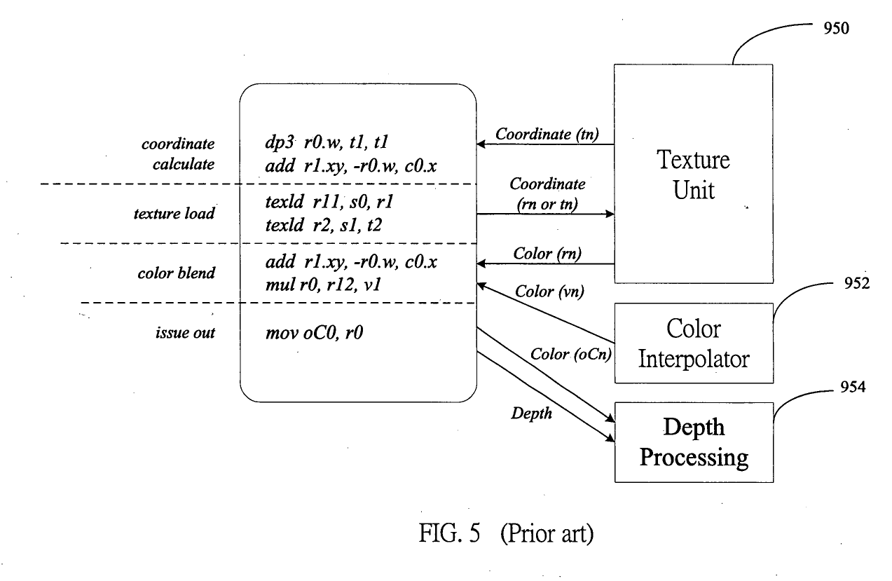

FIG. 6 illustrates a block diagram of a conventional pixel shader;

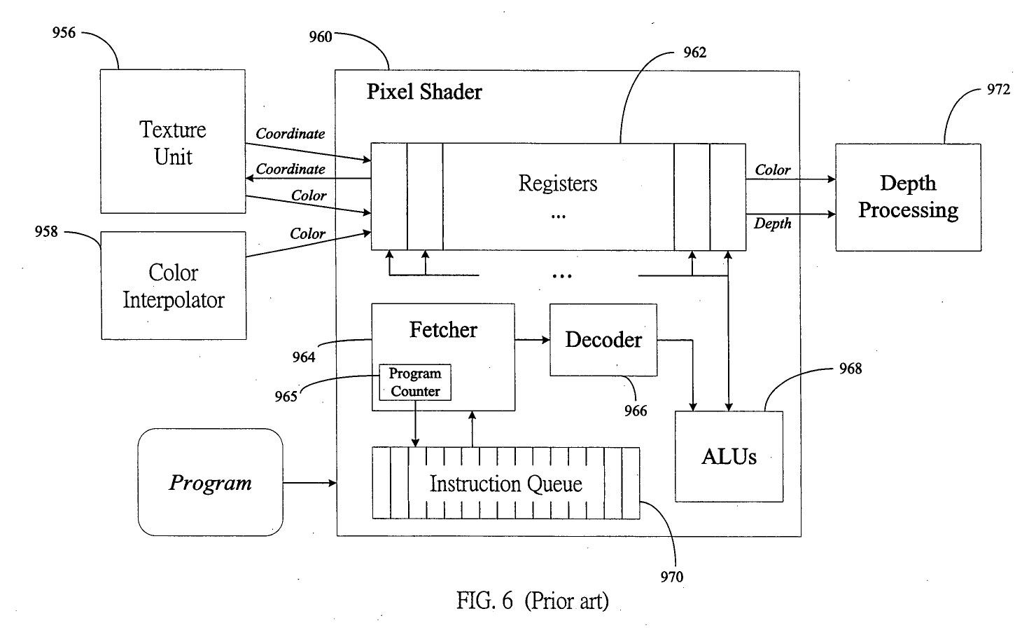

FIG. 7 illustrates an executing schedule of the pipeline of the conventional pixel shader and texture unit;

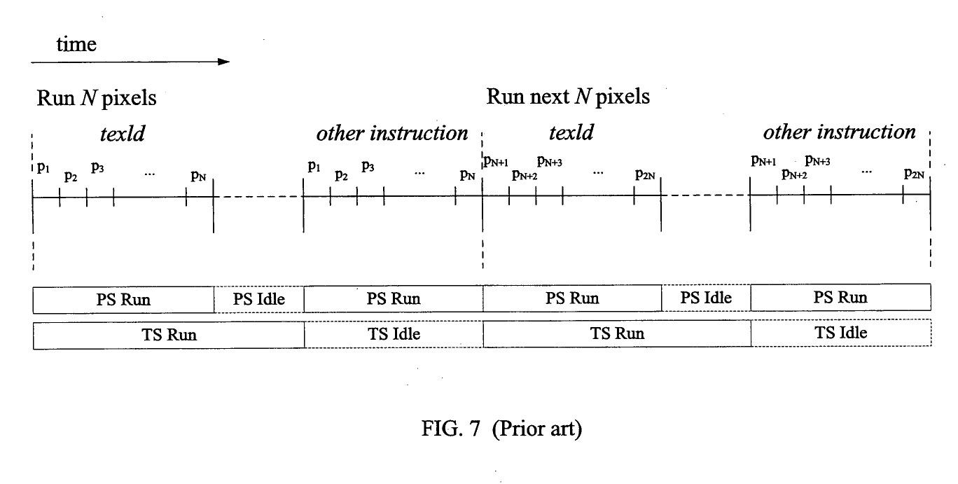

FIG. 8 shows a simplified block diagram of a graphic processor with the instruction removing mechanism in accordance with the present invention;

FIG. 9 shows an example for scanning and removing a simple texld instruction;

FIG. 10 shows another embodiment of the present invention which comprises a texld transforming unit;

FIG. 11 shows an example of the simple texld instruction removing mechanism according the present invention;

FIG. 12 shows a more simplified example of the removing mechanism according to the present invention;

FIG. 13 shows the executing schedule of the simple texld instruction removing mechanism according to the present invention;

FIG. 14 shows a detailed example of the executing schedule of the pixel shader and texture unit;

FIG. 15 shows a more specific example for illustrating the executing schedule of the pixel shader and texture unit;

FIG. 16 shows a flowchart for performing a method of removing the simple texld instructions in according to the present invention; and

FIG. 17 shows a flow chart of another embodiment of the method according to the present invention.

### DETAILED DESCRIPTION OF THE PREFERRED EMBODIMENTS

The present invention is directed to a mechanism and method thereof for removing a simple instruction in the graphic processes. Please note that the embodiments in the specification are instanced by the DirectX standard. However, the spirit of the present invention also can be implemented in other graphic process languages or hardwares, such as OpenGL language.

A simple texture load instruction (texld instruction) means that the texture coordinate of the texld instruction is directly obtained from the texture unit by an interpolated calculation, that is, the texture coordinate of the texld instruction never be processed by the pixel shader. In the DirextX standard, it means that the texture coordinate of the texld instruction is tn, otherwise the texld instruction is called non-simple texld instruction which the texture coordinate of the texld instruction is rn. A simple texld instruction comprises several operational factors which includes a target register rn, a texture number register sn, a texture coordinate register tn. In the DirextX standard, the format of simple texld instruction is [texld rn, sn, tn]. The texture unit can fetch the texture of the simple texld instruction without executing by the pixel shader. Therefore, the simple texld instruction can be removed from the program of the pixel shader.

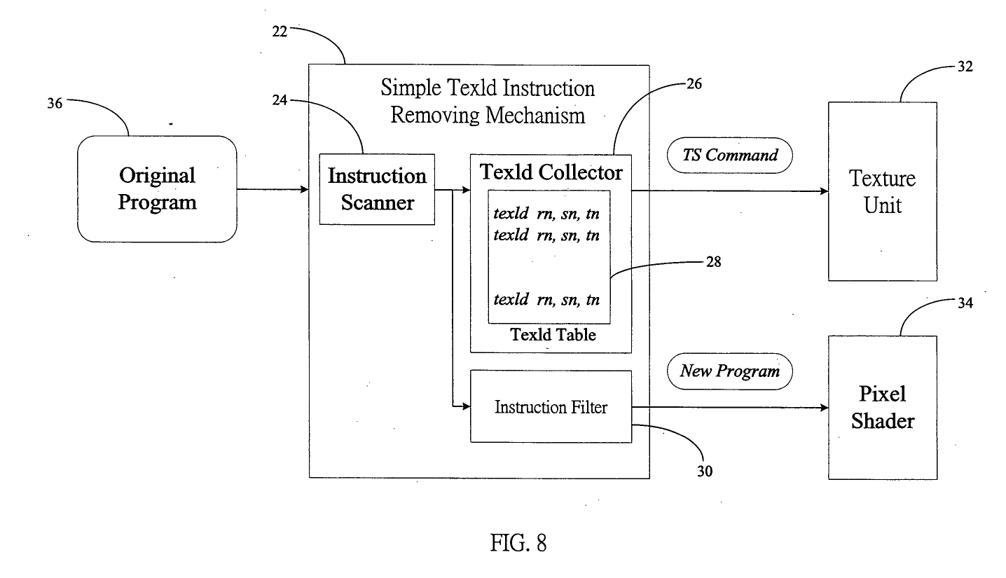

FIG. 8 is a simplified block diagram of a graphic processor 20 with the simple instruction removing mechanism 22 in accordance with the present invention. The graphic processor 20 comprises a simple texld instruction removing mechanism 22, a texture unit 32 and a pixel shader 34. The simple texld instruction removing mechanism 22 includes an instruction scanner 24, a texld collector 26 and an instruction filter 30. The instruction filter 30 is capable of decoding and scanning the instructions in an original program 36 according to the static status (non-dynamic status) of the instructions to determine whether an instruction is a simple texld instruction. In the DirectX standard, the simple texld instruction means that the texture coordinate thereof is tn.

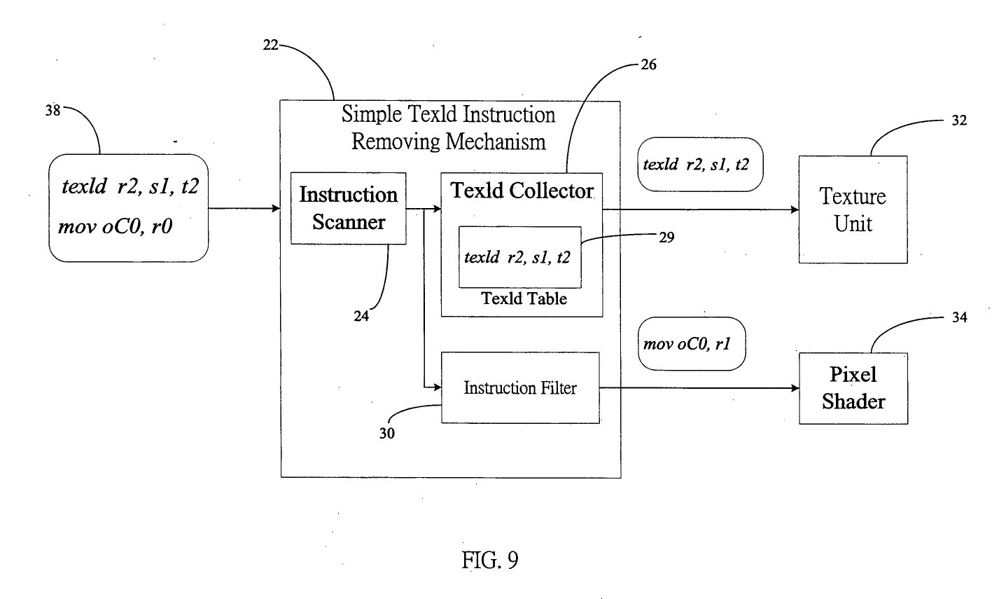

FIG. 9 shows an example for scanning and removing a simple texld instruction. A simple texld instruction [texld r1, s1, t0] in original program is found and deleted by the simple texld instruction removing mechanism 22. Subsequently, the simple texld instruction [texld r1, s1, t0] is stored into a texld table 29. After scanning by the instruction scanner 24 of the simple texld instruction removing mechanism 22, the instruction filter 30 filters out the simple texld instruction from the original program and the simple texld instruction will be written into the texld table 29.

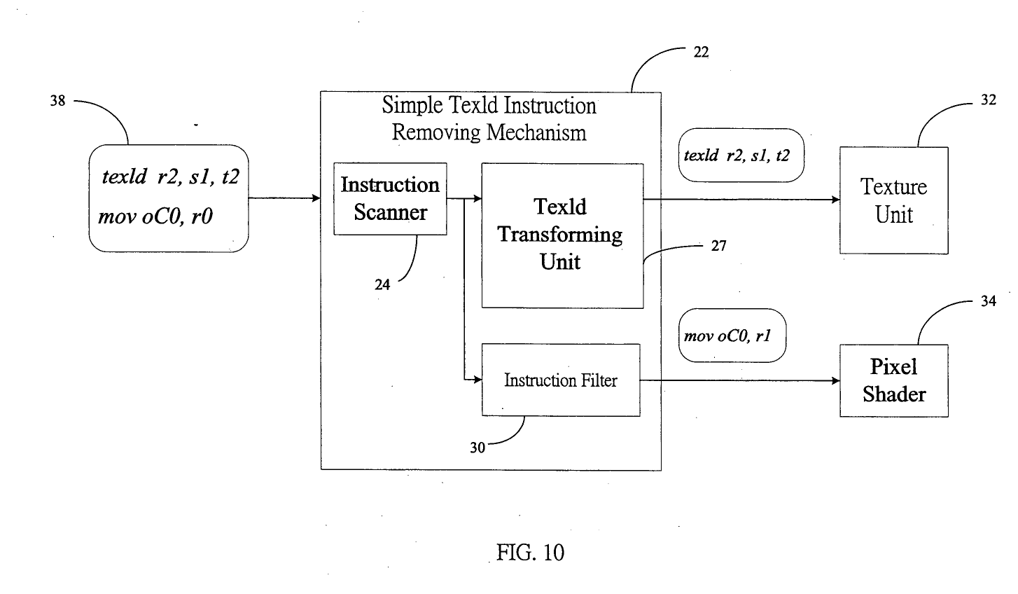

FIG. 10 illustrates another embodiment of the present invention which comprises a texld transforming unit 27 instead of the texld collector 26 shown in FIG. 9. The texld transforming unit 27 is capable of transforming the simple texld instructions and transmitting to the texture unit 32 for executing.

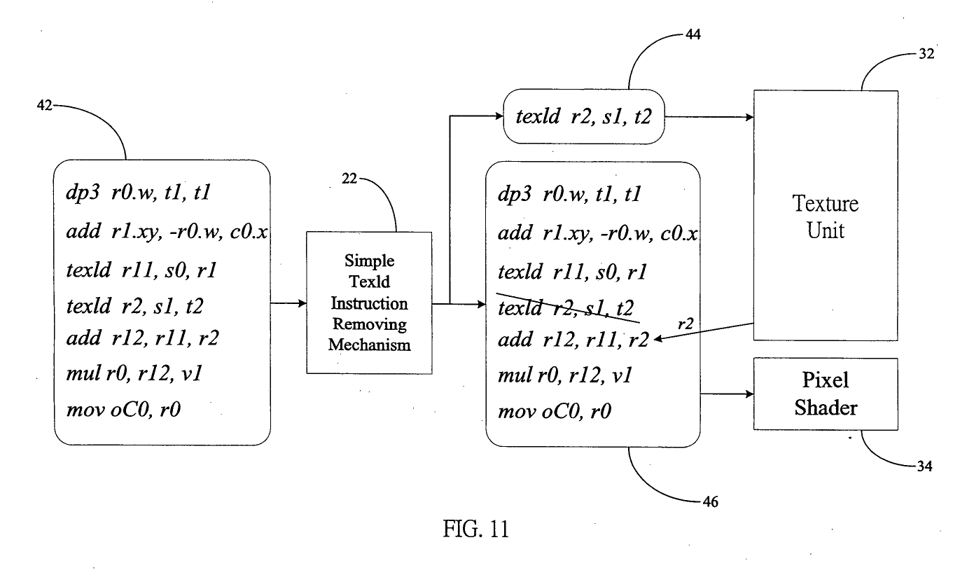

Referring to FIG. 11, FIG. 11 illustrates an example of a common pixel shader program 42 in which a simple texld instruction is removed by the removing mechanism 22 according the present invention. The removing mechanism 22 scans the original program 42 and finds a simple texld instruction [texld r2, s1, t2] (the texture coordinate is t2), then the simple texld instruction [texld r2, s1, t2] will be removed from the original program 42. Subsequently, the simple texld instruction [texld r2, s1, t2] will be transmitted to the texture unit 32 for directly fetching the texture of the simple texld instruction. Unlike that the instructions of the program have the order relations of program counter in the pixel shader, there is no control dependency between the texture load instructions in the texture unit. Thus the texture unit can fetch textures more efficient without the limitation of the control dependency.

The removing mechanism in accordance with the present invention can be implemented in a hardware form or a software form. The software of the removing mechanism can be an individual application program, a program loader or a portion of the device driver program. The portion of the device driver can be attached with the program compiler. The hardware of the removing mechanism can be contained in the GPU or pixel shader. The removing mechanism should be worked before the fetch or decoding the pixel shader instructions.

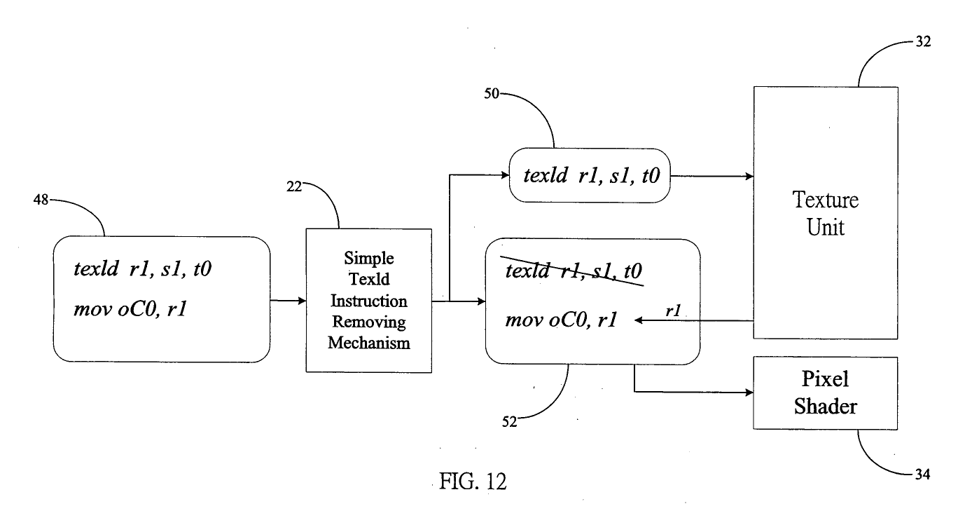

FIG. 12 illustrates a more simplified example of the simple texld instruction removing mechanism according to the present invention. An original program 48 comprises two instructions [texld r1, s1, t0] and [mov oC0, r1]. Because [texld r1, s1, t0] is a simple texld instruction (its texture coordinate is t0), the removing mechanism 22 removes the simple texld instruction [texld r1, s1, t0] from the original program 48 and transmit it to the texture unit 32.

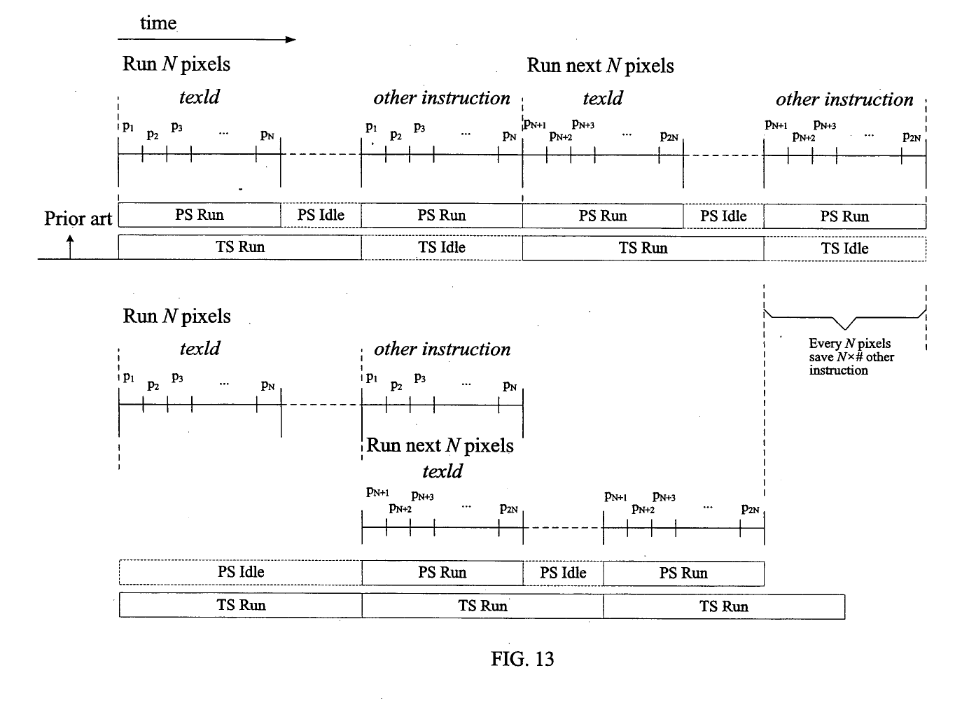

Please refer to FIG. 13. The upper half of FIG. 13 illustrates the executing schedule without the simple texld instruction removing mechanism and the bottom half of FIG. 13 with the simple texld instruction removing mechanism. Because the simple texld instructions are not removed from the original program, the texture unit have to be idled for N×i cycles when the pixel shader executing the non-simple instructions, wherein N is the number of the pixels which the pixel shader can execute in a same batch and i is the number of the non-simple instructions. In the bottom half of FIG. 13, the simple texld instructions are directly executed by the texture unit, so the pixel shader can execute the texture fetching of next N pixels in the meantime. The simple texld instructions do not have to comply with the control order or the bandwidth of the pixel shader, hence the texture coordinates of the simple texld instructions are not need to wait for the executing results of the pixel shader. Furthermore, the removing mechanism can check the data dependency in the static phase of the original program for saving the cost of complicated hardware of the pixel for checking data dependency. Therefore, the removing mechanism is capable of saving the idle time of the texture unit and keeping the texture unit in running for improving the performance of graphic process.

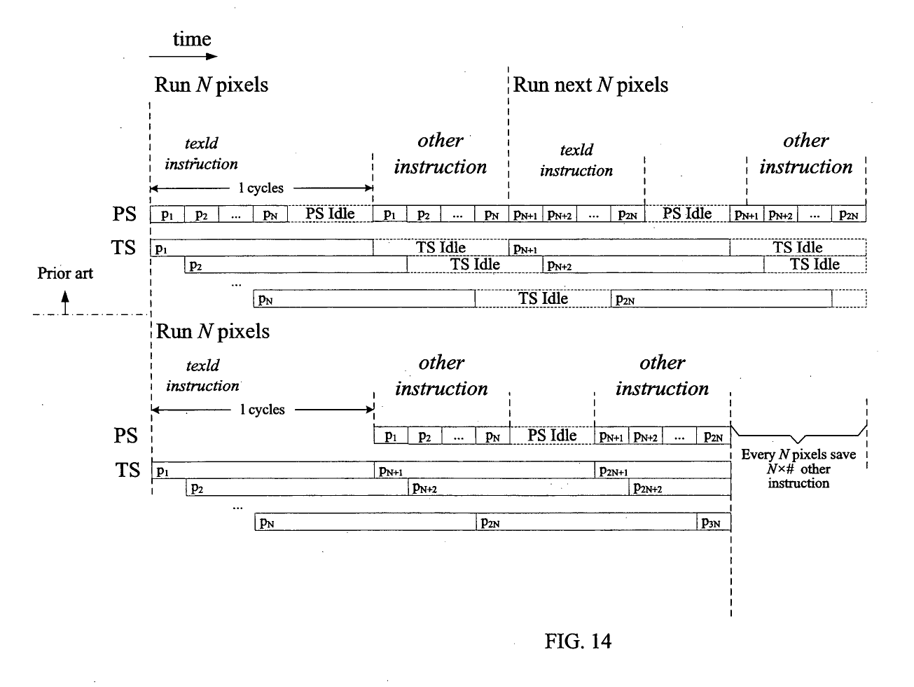

FIG. 14 shows a detailed example of the executing schedule of the pixel shader and texture unit with and without the simple texld instruction removing mechanism. In this example, we assume that the pixel shader and texture unit are capable of executing N instructions in a same batch and the texture unit takes l cycles for executing each instruction. Similar to FIG. 13, the texture unit have to be idled when the pixel shader executing not-simple instructions. In the bottom half of FIG. 14, the texture unit can execute the simple texld instructions continuously without waiting the executing results of the pixel shader. Thus the texture unit can save N×i cycles for every N pixels, wherein N is the number of the pixels which the pixel shader can execute in a same batch and i is the number of the non-simple instructions.

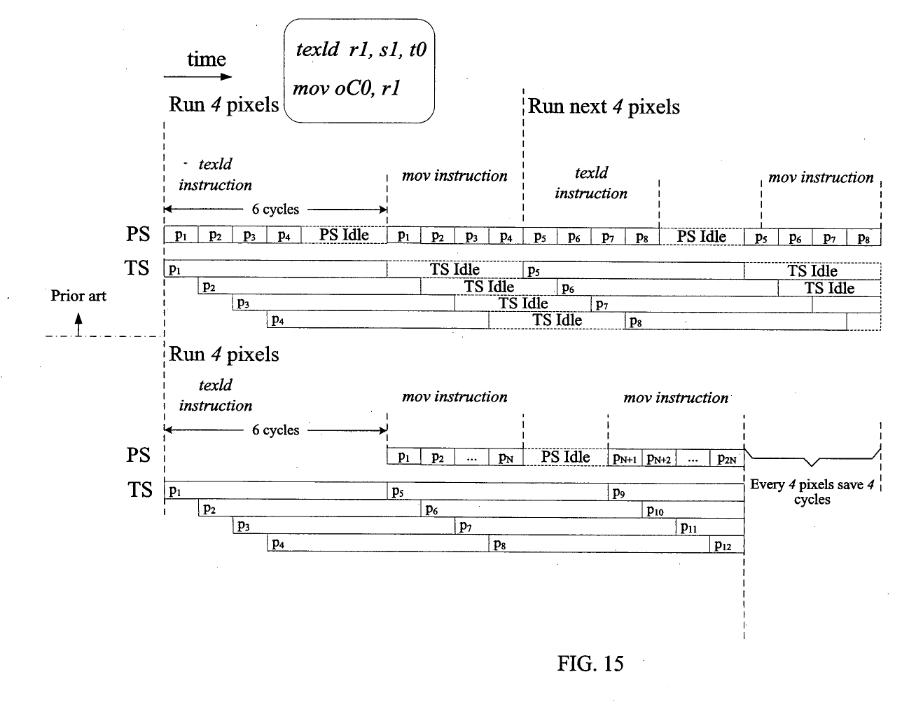

Comparing to FIG. 14, FIG. 15 is a more specific example for illustrating the executing schedule of the pixel shader and texture Unit with and without the simple texld instruction removing mechanism. In this example, the original program includes a simple texld instruction [texld r1, s1, t0] and another instruction [mov oC0, r1], and the pixel shader and the texture unit can execute 4 pixels in a same batch. Similar to FIG. 14, the texture unit with the removing mechanism can save 4 cycles for executing every 4 pixels.

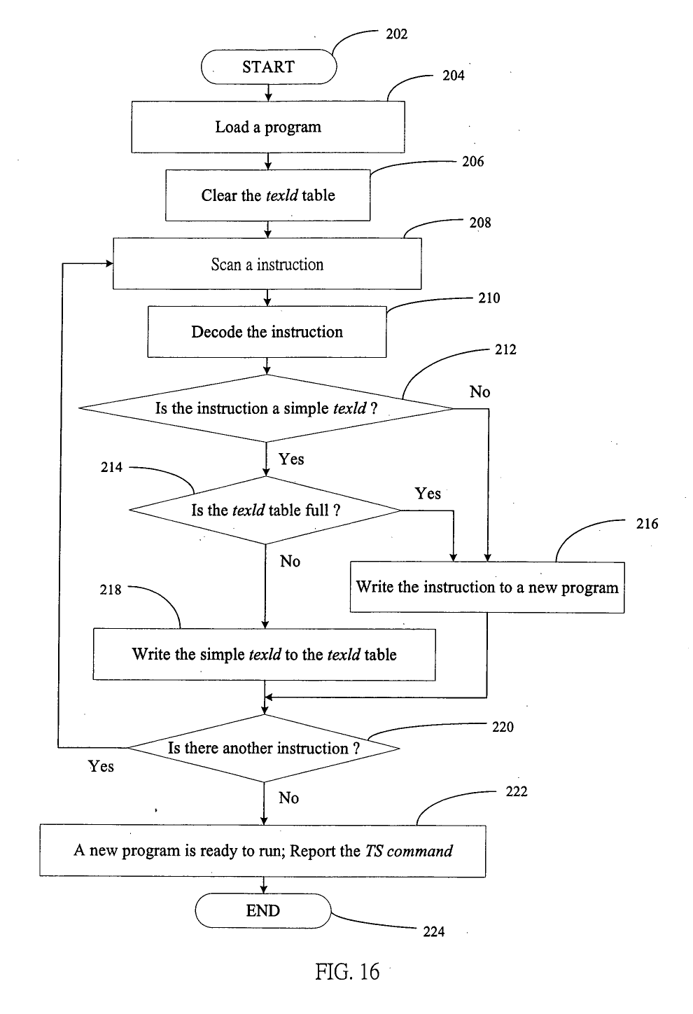

FIG. 16 is a flowchart showing a method of removing the simple texld instructions in according to the present invention. The method comprises the steps of:
Step 202 Start;
Step 204 Loading a original pixel process program;
Step 206 Clearing the texture table;
Step 208 Scanning a instruction in the original program;
Step 210 Decoding the instruction;
Step 212 Determining whether the instruction is a simple texld instruction, if so, go to step 214; else go to step 216;
Step 214 Checking if the texld table is full, if so, go to step 216; else go to step 218;
Step 216 Writing the instruction to a new program;
Step 218 Writing the simple texld instruction to the texld table;
Step 220 Determining whether there is another instruction, if so, go to step 208; else go to step 222;
Step 222 Ready to run a new program and transmitting the texture commends to the texture unit;
Step 224 End.

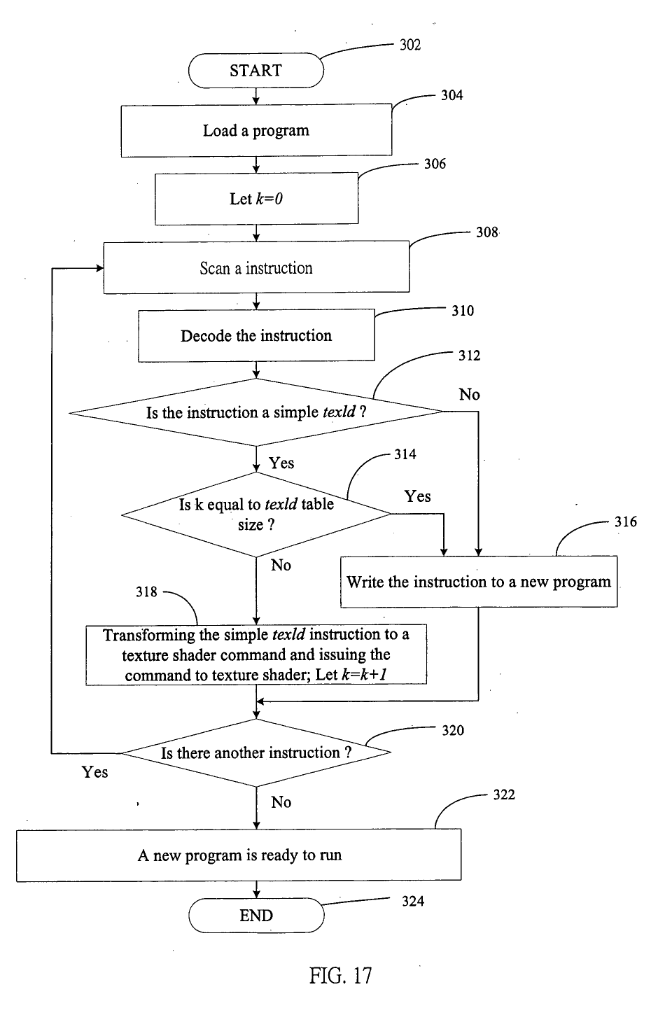

Referring to FIG. 17, the method according to the embodiment shown in FIG. 10 which comprises the texld transforming unit 27 instead of the texld collector 26 shown in FIG. 9. The method comprises the steps of:
Step 302 Start;
Step 304 Loading a original pixel process program;
Step 306 Let k=0;
Step 308 Scanning a instruction in the original program;
Step 310 Decoding the instruction;
Step 312 Determining whether the instruction is a simple texld instruction, if so, go to step 314; else go to step 316;
Step 314 Checking if k is equal the number of a predetermined texld table size in the texture unit, if so, go to step 316 else go to step 318;
Step 316 Writing the instruction to a new program;
Step 318 Transforming the simple texld instruction to a texld command and issuing the texld command to the texture unit, then let k=k+1;
Step 320 Determining whether there is another instruction, if so, go to step 308; else go to step 322;
Step 322 Ready to run a new program;
Step 324 End.

The advantages of the present invention include: (a) improving the performance of the graphic process, (b) reducing the idle time of the texture unit, (c) providing a simple texld instruction removing mechanism and method thereof to efficiently utilize the physical registers allocated to the graphic programs.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An instruction removing mechanism comprising:
an instruction scanner scanning an instruction to determine the instruction being a first type instruction or a second type instruction;
a texture rendering unit; and
a pixel rendering unit;
wherein the instruction scanner transmits the instruction being the first type instruction to the texture rendering unit and transmits the instruction being the second type instruction to the pixel rendering unit, and the texture rendering unit processes and transmits the instruction being the first type instruction to the pixel rendering unit.

2. The instruction removing mechanism of claim 1, wherein the instruction scanner determines the type of the instruction according to whether the instruction being processed by the pixel rendering unit.

3. The instruction removing mechanism of claim 1, wherein the first type instruction is a simple texture load instruction and the second type instruction is not a simple texture load instruction.

4. The instruction removing mechanism of claim 1, further comprising an instruction collector for collecting the first type instruction and transforming the first type instruction to a texture shading command.

5. The instruction removing mechanism of claim 4, wherein the instruction collector comprises an instruction table for storing the first type instruction.

6. The instruction removing mechanism of claim 4, further comprising an instruction transforming unit for transforming the first type instructions to the texture shading command.

7. The instruction removing mechanism of claim 4, wherein the texture rendering unit comprises a command table for storing the texture shading command.

8. The instruction removing mechanism of claim 1, wherein the second type instruction is transmitted to the pixel rendering unit.

9. An instruction removing mechanism comprising:
an instruction scanner scanning an instruction to determine the instruction being a first type instruction or a second type instruction;
a texture rendering unit;
a pixel rendering unit; and
an instruction transforming unit;
wherein the instruction scanner transmits the instruction being the first type instruction to the texture unit and transmits the instruction being the second type instruction to the pixel unit, and the instruction transforming unit transforms the first type instruction to the texture shading command for processing by the texture rendering unit and transmits the processed first type instruction to the pixel rendering unit.

10. The instruction removing mechanism of claim 9, wherein the instruction scanner determines the type of the instruction according to whether the instruction being processed by the pixel rendering unit.

11. The instruction removing mechanism of claim 9, wherein the first type instruction is a simple texture load instruction and the second type instruction is not a simple texture load instruction.

12. The instruction removing mechanism of claim 9, the mechanism further comprising an instruction filter for preventing the first type instruction being transmitted to the pixel rendering unit directly.

13. The instruction removing mechanism of claim 9, wherein the texture rendering unit comprising a command table for storing the texture rendering commands.

14. The instruction removing mechanism of claim 9, wherein the second type instruction is transmitted to the pixel rendering unit.

15. An instruction removing mechanism comprising:
an instruction scanner scanning an instruction to determine the instruction being a first type instruction or a second type instruction;
a texture unit; and
a pixel shader;
wherein the instruction scanner transmits the instruction being the first type instruction to the texture unit and transmits the instruction being the second type instruction to the pixel shader, and the texture unit processes and transmits the instruction being the first type instruction to the pixel shader.

16. The instruction removing mechanism of claim 1, wherein the instruction scanner determines the type of the instruction according to whether the instruction being processed by the pixel shader.

17. The instruction removing mechanism of claim 15, further comprising an instruction filter for preventing the first type instruction being transmitted to the pixel shader directly.

18. The instruction removing mechanism of claim 15, wherein the first type instruction is a simple texture load instruction and the second type instruction is not a simple texture load instruction.

19. The instruction removing mechanism of claim 18, further comprising an instruction collector for collecting the simple texture load instruction and transforming the format of the simple texture load instruction to the texture rendering instruction.

20. The instruction removing mechanism of claim 19, wherein the instruction collector comprising an instruction table for storing the simple texture load instruction.

21. The instruction removing mechanism of claim 15, wherein the texture unit comprising an instruction table capable of storing the texture rendering instructions.

22. The instruction removing mechanism of claim 15, wherein the second type instruction is transmitted to the pixel shader.

23. An instruction removing method coupled to a graphic processing mechanism, said graphic processing mechanism comprising a pixel rendering unit, a texture rendering unit, and an instruction scanner, the method comprising the steps of:
determining an instruction being a first type instruction or a second type instruction by the instruction scanner according to whether the instruction being processed by the pixel rendering unit;
storing the first type instruction into an instruction table;
transforming the format of the first type instruction stored in the instruction table;
transmitting the first type instruction to the texture rendering unit;
removing the first type instruction from a original graphic processing program; and
generating a new program and transmitting the new program to the pixel rendering unit.

24. The instruction removing method of claim 23, wherein the first type instruction is a simple texture load instruction and the second type instruction is not a simple texture load instruction.

25. The instruction removing method of claim 23, further comprising a step of decoding the instruction before determining the type of the instruction.

26. The instruction removing method of claim 23, further comprising a step of checking the status of the instruction table after determining the type of the instruction.

27. An instruction removing method coupled to a graphic processing mechanism, said graphic processing mechanism comprising a pixel rendering unit, a texture rendering unit, and an instruction scanner, the method comprising the steps of:
determining an instruction being a first type instruction or a second type instruction by the instruction scanner according to whether the instruction being processed by the pixel rendering unit;
transforming the format of the first type instruction;
transmitting the first type instruction to the texture rendering unit;
removing the first type instruction from a original graphic processing program; and
generating a new program and transmitting the new program to the pixel rendering unit.

28. The instruction removing method of claim 27, wherein the first type instruction is a simple texture load instruction and the second type instruction is not a simple texture load instruction.

29. The instruction removing method of claim 27, further comprising a step of decoding the instruction before determining the type of the instruction.

30. The instruction removing method of claim 27, further comprising a step of storing the first type instruction into an instruction table of the texture rendering unit after the step of transmitting the first type instruction to the texture rendering unit.

31. An instruction removing method coupled to a graphic processing mechanism, said graphic processing mechanism comprising a pixel shader, a texture unit, and an instruction scanner, the method comprising the steps of:
decoding an instruction;
determining the instruction being a first type instruction or a second type instruction by the instruction scanner according to whether the instruction being processed by the pixel rendering unit;
transforming the format of the first type instruction to a texture rendering instruction;
transmitting the texture rendering instruction to the texture unit;
storing the texture rendering instruction into the texture unit;
removing the first type instruction from a original graphic processing program; and
generating a new program for the pixel shader executing.

32. The instruction removing method of claim 31, wherein the first type instruction is a simple texture load instruction and the second type instruction is not a simple texture load instruction.

33. The instruction removing method of claim 31, wherein said graphic processing mechanism further comprising an instruction collector for collecting the simple texture load instructions and transforming the format of the simple texture load instruction to the texture rendering instructions.

34. The instruction removing method of claim 33, wherein the instruction collector comprising an instruction table for storing the simple texture load instructions.

35. The instruction removing method of claim 31, wherein the texture unit comprising an instruction table for storing the texture rendering instructions.

36. The instruction removing method of claim 31, wherein the second type instruction is transmitted to the pixel shader.
